(19) United States
(12) Patent Application Publication
(10) Pub. No.: US 2026/0263887 A1
(43) Pub. Date: Sep. 10, 2026

(54) SYSTEM FOR FIXATION OF INSET CLIMBING HOLDS

(71) Applicant: Alexander KOZLOV, Taufkirchen (DE)

(72) Inventor: Alexander KOZLOV, Taufkirchen (DE)

(21) Appl. No.: 19/483,366

(22) PCT Filed: Mar. 22, 2024
(86) PCT No.: PCT/IB2024/052768

§ 371 Date: Nov. 11, 2025

(30) Foreign Application Priority Data
Mar. 23, 2023 (WO) PCT/IB2023/052853

(51) Int. Cl. A63B 69/00

(52) U.S. Cl. CPC A63B 69/0048

(57) ABSTRACT

Claimed is a system for fixation of inset climbing holds, comprising a receiving recess formed by a receiving hole on the outer surface of an artificial climbing structure, a receiving element with inset lateral walls made to cover a lateral surface of a body provided for mounting the inset climbing hold into the receiving recess and having an end surface directed from the outer surface of the artificial climbing structure and a removable bottom of the receiving element, arranged on an end surface of the inset lateral walls of the receiving element faced from the outer surface of the artificial climbing structure, spaced at a set distance from the inset surface of the artificial climbing structure, being designed for adjoining to a base provided for mounting into the receiving recess of the inset climbing hold, and being designed for fixation of the inset climbing hold with its base to said bottom by means of at least one fixation element. Claimed is also an inset climbing hold for fixation in such a receiving recess, having a cylindrical body and a single through mounting and fixation hole that is arranged in the body from the outer working surface to the base, the axis of which is parallel to and not coincident with the axis of symmetry of a cylindrical body of the hold.

### TECHNICAL FIELD

The present invention relates to a system for fixation of inset climbing holds. Provided is a design of receiving recesses on an artificial climbing structure for fixing the inset climbing holds therein.

### BACKGROUND

Climbing holds are removable sports climbing equipment to be mounted on an artificial climbing structure. In the context of this application, an artificial climbing structure means artificial surfaces for climbing, such as outer surfaces of climbing wall panels from which artificial walls for climbing are designed, or outer surfaces of other climbing holds fixed to the outer surfaces of the climbing wall panels or other climbing holds.

Routes for climbing are formed using climbing holds of various shapes and sizes, with their fixation at various distances from each other on the artificial climbing structure. A climber climbs the artificial climbing structure using climbing holds, that is, loading them with hands and feet.

Climbing holds are divided into three categories. Each category is defined by a material and/or manufacturing process, rather than a size.

Definitions of climbing holds categories according to the IFSC (International Federation of Sport Climbing) are:
Holds—climbing holds, made of polyester, polyurethane resin or solid wood.
Macroses—hollow back climbing designs made of laminated fibers (fiberglass, carbon, coconut, etc.) or vacuum-formed plastic with a resin coating (polyurethane, polyester or other materials).
Structures—hollow back climbing designs made of wood (plywood and other wood-based panels).

In the context of this application, climbing holds refer to all three categories-holds, macroses and structures.

Depending on a mounting method, all climbing holds can be divided into two types:
External—these climbing holds are fixed directly to a surface of the artificial climbing structure with a lower flat surface (base) and extend above it in a set position.
Inset—these climbing holds require the availability in a surface of the artificial climbing structure of receiving recesses or receiving holes matching to inset climbing holds of shapes and sizes equipped with auxiliary support elements. When mounted, only the upper surface of the inset climbing hold is visible on the surface of the artificial climbing structure. Inset climbing holds mounted into a receiving recess are lowered into the artificial climbing structure and usually do not extend above the outer surface. An inset climbing hold is typically shaped as a regular cylinder, truncated cone, or polygonal prism as disclosed, for example, in FR2623412A1 and FR2570610A1. Inset climbing holds usually have a central axis of rotation perpendicular to the surface of the artificial climbing structure. This allows the inset climbing hold to be rotated within a receiving recess.

As disclosed in JP2971038B2 and FR2570610A1, an inset climbing hold is fixed in a receiving recess which is an integral part of a climbing wall panel. An alternative embodiment of fixation an inset climbing hold to a climbing surface is disclosed in DE20308822U1 and JP2971038B2, wherein an auxiliary support element of a receiving recess is removable and is mounted on an inset surface of the climbing wall panel opposite a receiving hole in the climbing wall panel forming a bottom and a portion of lateral walls of a receiving recess, and constraining a depth of the inset climbing hold.

There are reversible inset climbing holds having two outer surfaces, which can be mounted in the receiving recess in two positions.

From the state of the art the following methods of fixation the inset climbing holds in receiving recesses in an artificial climbing structure of various types of fixation elements are known:
With a central bolt to a bottom of a receiving recess, which is an integral part of a climbing wall panel, as disclosed, for example, in JP2971038B2 and FR2623412.
With bolts or self-tapping screws inserted into holes or notches arranged along a perimeter of an outer washer-shaped edge of an inset climbing hold, pressing the washer-shaped edge of an inset climbing hold against support elements arranged along the perimeter of a parent receiving hole, as disclosed for example in FR2627988A1.
With a few self-tapping screws to the bottom of the receiving recess.

The deficiencies of these technical solutions are:
The receiving recesses, which are integral parts of the climbing wall panels described in JP2971038B2 and FR2623412, are complex in production and maintenance, for example in case of a damage of the hole thread, to which the inset climbing hold is fixed by a thread element.
The removable auxiliary support element, described in DE 20308822U1, must be arranged only on climbing wall panels, which have a predetermined thickness, as otherwise the depth of the receiving recess that is formed thereby will not be equal to the height of the inset climbing holds arranged therein, which may lead to gripping of side surfaces of the inset climbing holds or receiving recesses not intended specifically for climbing.
The presence of an external washer-shaped edge increases the area of unused surface of the inset climbing hold described in FR2753632.

### SUMMARY

The object of the present invention is to provide a system for fixation of inset climbing holds on an artificial climbing structure:
Allowing to vary a depth of receiving recesses for inset climbing holds;
In the form of adapters allowing the mounting of additional smaller inset climbing holds, including with a different fixation system, into the receiving recesses for larger inset climbing holds;
Allowing to vary a profile of the outer surface of the parent outer climbing holds by replacing daughter inset climbing holds mounted in the receiving recesses on their outer surface.

These objects are implemented according to a climbing hold of claim 1 of the invention. The most preferred embodiments of the claimed invention are provided in the dependent claims.

Claimed is a fixation system on an artificial climbing structure for fixing therein an inset climbing hold, wherein the artificial climbing structure has an outer and an inner surface and at least one receiving recess for fixation an inset climbing hold therein. The receiving recess is formed by a receiving hole on the outer surface of an artificial climbing structure, which, as mentioned above, can be either the outer surface of a climbing wall panel or the outer surface of other climbing holds fixed to or in the surfaces of the climbing wall panels. In addition, the receiving recess is also formed by a receiving element with inset lateral walls having an end surface directed inside the artificial climbing structure, i.e. in the direction from the outer surface of the artificial climbing structure and spaced at a set distance from the inner surface of the artificial climbing structure. Inset lateral walls of the receiving element are made to cover a lateral surface of a body provided for mounting the inset climbing hold into the receiving recess. At least portion of the bottom of the receiving element is made as a separate removable part adjacent to this end surface and designed for demountable fixation to an edge portion of the inset lateral walls of the receiving element. In this case, the bottom of the receiving element is made to adjoin to the base of the inset climbing hold provided for mounting in this receiving recess, as well as to fix the inset climbing hold with its base to this bottom with at least one fixation element. This design allows to replace the removable part of the bottom in case of its wear, for example, if the fixation elements are screw fixation elements.

According to another embodiment of the invention, the artificial climbing structure described above is a parent outer or inset climbing hold, which allows, if required, to change a shape of a portion of an outer surface of the parent hold on which a daughter receiving recess is arranged, by mounting daughter inset holds of various shapes in the recess.

According to yet another embodiment, at least a portion of inset lateral walls of a receiving element is made as a separate removable mounting sleeve for fixation by its upper end surface to an inset surface of an artificial climbing structure opposite to a hole a receiving recess, as well as for fixation to its lower end surface of a removable part of a bottom of the receiving element. This allows to change a depth of the receiving recess, if required, either upward or downward, for example in the case wherein a thickness of the artificial climbing structure differs from the standard one, for which a removable mounting sleeve was made. For this purpose, it is enough to remove the center or an edge portion of a removable part of a bottom by a difference of a thickness of the artificial climbing structure in comparison with the standard one.

According to another embodiment of the invention, an artificial climbing structure, described above, is a parent external climbing hold with fixation holes arranged on the bottom and/or lateral walls of the parent receiving recesses, which allows after fixation of the parent hold on the surface of the artificial climbing structure to hide the fixation elements by mounting the daughter inset climbing holds in these parent receiving recesses. The fixation system allows for a simple and secure fixation of the external parent climbing hold on the outer surface of the artificial climbing structure using hidden fixation elements of a standard size.

According to another embodiment of the invention, the artificial climbing structure, described above, is a double-sided reversible parent inset climbing hold made in the form of a three-dimensional part with an outer washer-shaped edge resting, when mounted, on a support portion protruding inside the receiving hole, such a type of inset climbing hold is known as a disk. A daughter receiving recess in this embodiment of the invention is formed by fixing a removable mounting sleeve with a bottom on an edge of a daughter receiving recess on a side of a disc which will be its base in the mounted position, which allows the use of a daughter inset climbing hold to mount the daughter inset climbing holds, regardless of which side outward the parent climbing hold is mounted in the parent receiving hole.

According to another embodiment of the invention, a reversible double-sided inset climbing hold having a cylindrical body to be mounted in a receiving recess, has a single through mounting and fixation hole, whose axis is parallel to and not coincident with the axis of symmetry of a cylindrical body of the hold. This fixation system allows a simple and reliable fixation of an inset climbing hold in a receiving recess of an artificial climbing structure with a standard-sized fixation element arranged on an edge of an upper surface, rather than in the center, as in an inset climbing hold having conventional design, which, on the one hand, prevents the rotation of the hold inside the receiving recess under load, and on the other hand allows the use of a larger portion of the outer surface for climbing.

### BRIEF DESCRIPTION OF DRAWINGS

The figures show:

FIG. 1—a cross-sectional perspective view of a receiving recess in an artificial climbing structure.

FIG. 2—a cross-sectional perspective view of the inset climbing hold, mounted in a receiving recess on the artificial climbing structure according to FIG. 1.

FIG. 3—a cross-sectional perspective view of the embodiment of an external climbing hold with a receiving recess.

FIG. 4—a cross-sectional perspective view of the embodiment of a parent inset climbing hold with a daughter receiving recess.

FIG. 5—a perspective view of a removable mounting sleeve.

FIG. 6—a cross-sectional perspective view of a receiving recess in an artificial climbing structure with the removable mounting sleeve according to FIG. 5, fixed with self-tapping screws.

FIG. 7—a cross-sectional perspective view of a receiving recess in an artificial climbing structure with the removable mounting sleeve according to FIG. 5, fixed with screws.

FIG. 8—a cross-sectional perspective view of the embodiment of an external climbing hold with two receiving recesses and two fixation elements.

FIG. 9—a perspective view of embodiment of an inset climbing hold in a cross-section and as a whole.

FIG. 10—a cross-sectional perspective view of the external climbing hold according to FIG. 8 with two inset holds mounted in receiving recesses.

FIG. 11—a cross-sectional perspective view of the embodiment of a double-sided inset climbing hold with a daughter receiving recess with the removable mounting sleeve according to FIG. 6, mounted in a parent receiving recess on an artificial climbing structure.

FIG. 12—a cross-sectional perspective view of the double-sided inset climbing hold according to FIG. 11 with a daughter receiving recess with a removable mounting sleeve according to FIG. 6, mounted into a parent receiving recess on an artificial climbing structure with the other side.

FIG. 13—a cross-sectional perspective view of the inset climbing hold according to FIG. 2, mounted in the receiving recess according to FIG. 6 deeper than a height of the inset climbing hold.

FIG. 14—a cross-sectional perspective view of a bottom of the receiving recess according to FIG. 13.

FIG. 15—a cross-sectional perspective view of the inset climbing hold according to FIG. 2, mounted in the receiving recess according to FIG. 6 of a lower depth than a height of the inset climbing hold.

FIG. 16—a cross-sectional perspective view of a bottom of the receiving recess according to FIG. 15.

### DETAILED DESCRIPTION OF THE EMBODIMENTS

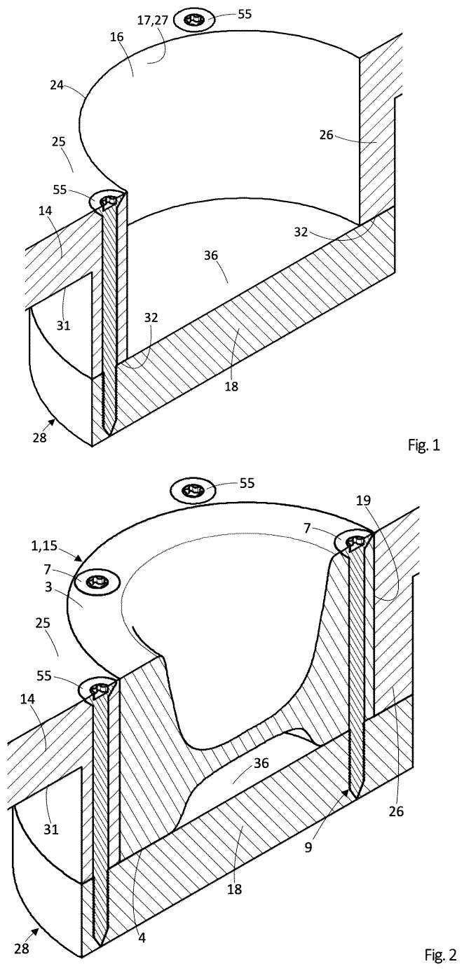

FIG. 1 illustrates a cross-sectional perspective view of the artificial climbing structure 14 made in the form of a climbing wall panel with a receiving recess 16. The structure 14 has an outer surface 25, an inset surface 31 and the receiving recess 16 with inset lateral walls 17 and a bottom 18. The recess 16 is formed by a receiving hole 24 on a surface 25 of the structure 14, inset lateral walls 27 of a receiving element 26 and an outer surface 36 of a removable part 28 of the bottom. The receiving element 26 is formed in the shape of an inner protrusion of the structure 14, wherein the protrusion has a uniform thickness in cross-section, parallel to the receiving hole 24 and spaced from the inner surface 31 of the structure 14. Preferably, the shape of the cross-section of the receiving element 26 is round, i.e. washer-shaped and equal along the whole height of the protrusion from the inset surface 31 to a lower end part 32 of the inset lateral walls 27 of the receiving element 26. Alternatively, the shape of the cross-section can be of a shape different from round, in this case the thickness of the walls of the receiving element can vary. The part 28 in this embodiment of the invention is made in the shape of a flat cylinder with a diameter equal to the outer diameter of the protrusion of the receiving element 26 and is fixed with a threaded fixation to the artificial climbing structure 14 facing from the outer surface 25 of an end portion of the walls 27 of the receiving element 26 with fixation elements 55 protruding from the outer surface 25 through the lateral walls 27 of the receiving element 26. The fixation elements 55 can be threaded fixation elements. Alternatively, the part 28 may be made in any other form, which is configured for arrangement a demountable fixation element spaced at a given distance from the surface 25 of the structure 14 to the outer surface 36 of the removable part 28 of the bottom.

FIG. 2 illustrates a cross-sectional perspective view of the structure 14 according to FIG. 1, the double-sided reversible inset hold 1 mounted and partially fixed in its recess 16 by three fixation elements 7 (only two of them are shown) through fixation through-holes with conical recesses in the form of heads of screw fixation elements 7. The fixation elements 7 are already fixed in the bottom 18 of the recess 16. In the process of fixation of the hold 1, 15 to the bottom 18 a tight threaded connection is achieved between the fixation portion 9 of the fixation elements 7 and the bottom 18 from the outer surface 36 of the bottom 18. A shape of the recess 16 of the structure 14 matches the shapes and dimensions of the hold 1, 15 being designed for its fixation with the surface 3 flush to the surface 25 of the structure 14. Alternatively, any threaded connection, such as screws being screwed into threaded inserts mounted on the inset surface of the bottom 18 of the recess 16 (not shown), can be used to fix the hold 1, 15 shown in FIG. 2. The shape and dimensions of the recess 16 match to the shapes and dimensions of the outer lateral surface of the hold 1, 15, namely its maximum dimensions in the plane of cross-section passing parallel to the outer working surface 3 and the base 4 of the hold 1, 15.

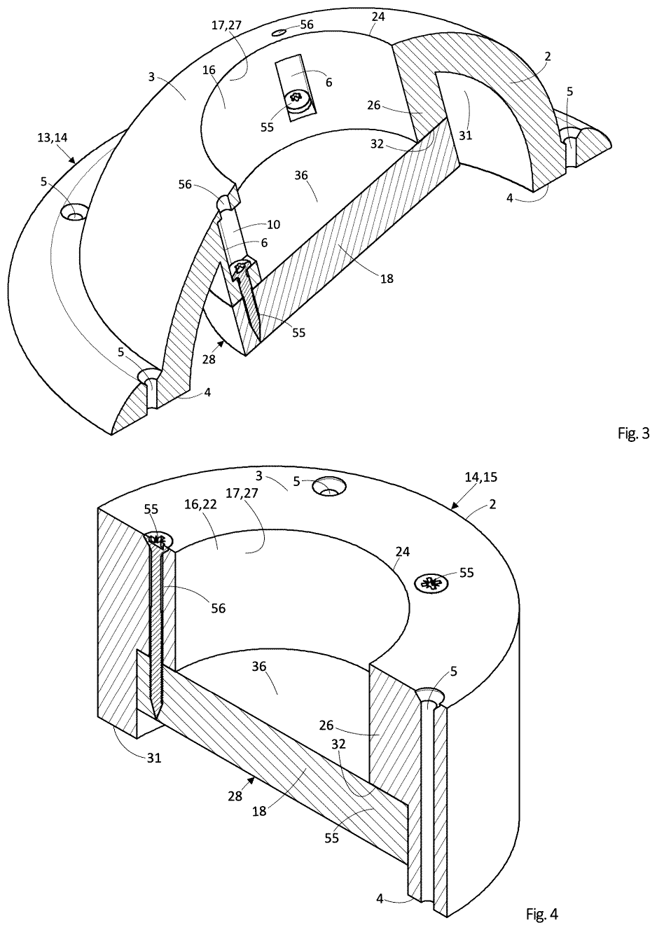

FIG. 3 illustrates a cross-sectional perspective view of an artificial climbing structure made as an external climbing hold 13, 14. The hold 13, 14 has the body 2, the outer surface 3, through fixation holes 5, the base 4 and the receiving recess 16 with inset lateral walls 17 and the bottom 18. The receiving recess 16 is formed by the receiving hole 24 on the surface 3 of the hold 13, 14, the inset lateral walls 27 of the receiving element 26 and the outer surface 36 of the removable part 28 of the bottom 18. The receiving element 26 is formed in the shape of an inner protrusion of the hold 13, 14. The part 28 is fixed to the directed from the outer surface 3 and spaced from the inset surface 31 end portion 32 of the walls 27 of the receiving element 26 by the fixation elements 55. In this embodiment of the invention, to mount the fixation elements 55 of the part 28, the through holes 56 of the surface 3 of the hold 13, 14 are made, with the extensions 6 with the lateral notches 10 on the walls 27 of the receiving element 26. Alternatively, the part 28 can be made in any other form, which is adapted for demountable fixation, spaced at a given distance from the outer surface 3 of the hold 13, 14.

FIG. 4 illustrates a cross-sectional perspective view of an artificial climbing structure made as the parent inset climbing hold 14, 15. The parent inset climbing hold 14, 15 has a body 2 made in the form of a ring cylinder and having the outer surface 3 and the base 4 as bases, as well as extending parallel to the cylinder axis (not shown) through fixation holes 5 with conical recesses in the form of heads of screw fixation elements and a daughter receiving recess 16, 22 with inset lateral walls 17 and a bottom 18. The recess 16, 22 is formed by the circular receiving hole 24 on the outer surface 3 of the hold 14, 15, by the inset lateral walls 17, 27 of the receiving elements 26 and by the outer surface 36 of the removable part 28 of the bottom. The part 28 is fixed to the directed from the outer surface 3 and spaced from the inset surface 31 end portion 32 of the walls 17, 27 of the receiving element 26 with fixation elements 55. In this embodiment of the invention, to mount the fixation elements 55 of the part 28, extending parallel to the cylinder axis (not shown) through holes 56 are made on the surface 3 of the hold 14, 15. Alternatively, the part 28 can be made in any other form, which is adapted for demountable fixation, spaced at a given distance from the surface 3 of the hold 14, 15.

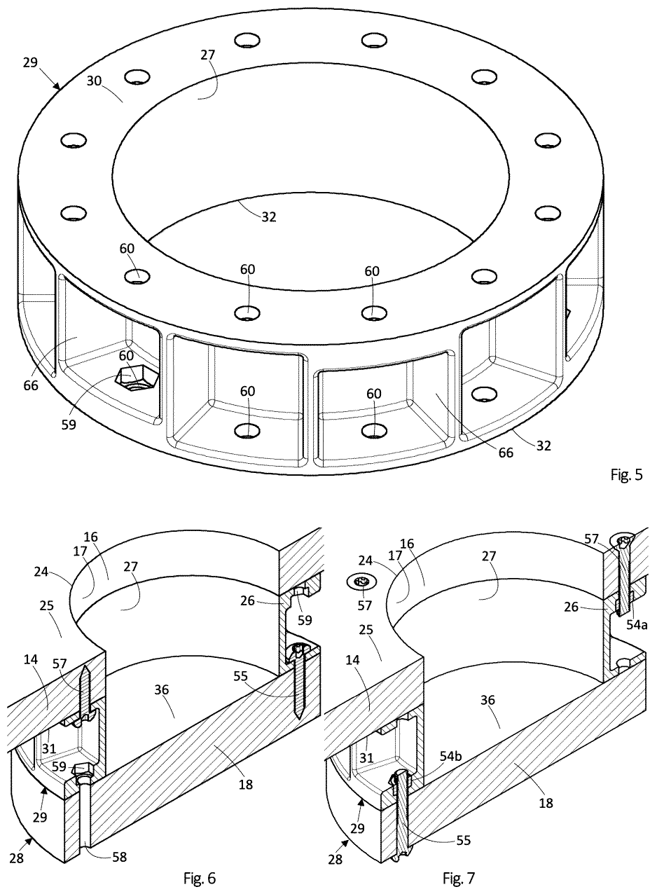

FIG. 5 illustrates a separate removable mounting sleeve 29. The sleeve 29 has a flanged upper end portion 30, a flanged lower end portion 32, and inset lateral walls 27 having a cylindrical shape and connecting the inset edges of the both flanges. The upper and lower end portions 30, 32 are connected to each other in the central and outer portions with crosspieces 66. Such a form of design of the mounting sleeve 29 makes it possible to achieve maximum strength with a minimal consumption of material. In this embodiment of the invention, the sleeve 29 is made as a universal fixation sleeve designed for fixation with its upper end portion 30 to the inset surface 31 of the artificial climbing structure 14 opposite to the receiving hole 24 of the receiving recess 16 and also for fixation to its lower end portion 32 of the removable bottom part 28 using various combinations of fixation elements 54, 55 and 57, as shown in FIG. 6 and FIG. 7. To this end, the sleeve 29 has the fixation holes 60 on its upper end portion 30 and slots for t-nuts 59 on its lower end portion 32. In this embodiment of the invention, standard nuts are used as t-nuts 59. Alternatively, the sleeve 29 may be made in any other form, which is configured for its demountable fixation to the inset surface 31 of the structure 14 opposite to the receiving hole 24 of the recess 16, as well as the fixation to the mounting sleeve 29 of the part 28.

FIG. 6 shows a cross-sectional perspective view of the artificial climbing structure 14 made in the form of a climbing wall panel. The structure 14 has the outer surface 25 and the receiving recess 16 with inset lateral walls 17 and the bottom 18. The recess 16 is formed by the receiving hole 24 on the outer surface 25 of the structure 14, the walls 17 of the recess 16, the inset lateral walls 27 of the sleeve 29 according to FIG. 5 and the outer surface 36 of the removable bottom part 28. In this embodiment of the invention the sleeve 29 fulfills the function of the receiving element 26, shown in FIGS. 1 and 2. The part 28 is fixed to the lower end portion 32 of the sleeve 29 with fixation elements 55 in the form of screws through the fixation holes 60. The sleeve 29 with the part 28 fixed thereon is fixed with its upper end portion 30 to the inset surface 31 of the structure 14 with fixation elements 57 in the form of screws through the fixation holes 60. To access the fixation elements 57, the part 28 has additional through holes 58 coaxially arranged with the fixation elements 57.

FIG. 7 illustrates a cross-sectional perspective view of the artificial climbing structure 14 made as a climbing wall panel similar to FIG. 13. The structure 14 has the outer surface 25 and the receiving recess 16 with inset lateral walls 17 and the bottom 18. The recess 16 is formed by the receiving hole 24 on the outer surface 25 of the structure 14, the walls 17 of the recess 16, the inset lateral walls 27 of the sleeve 29 according to FIG. 5, and the outer surface 36 of the part 28. The part 28 is fixed to the lower end portion 32 of the sleeve 29 with fixation elements 55 in the form of screws through holes 60 to the t-nuts 54b inserted in the slots 59 provided for them. The sleeve 29 is fixed with the upper end portion 30 to the inset surface 31 of the structure 14 with fixation elements 57 in the form of tapered head screws inserted from the outer surface 25 into additional through holes in the structure 14 with recesses in the form of fixation heads 57, through fixation holes 60 to the t-nuts 54a inserted in slots 59 provided for them. All the reference numbers in FIG. 5-FIG. 7 correspond to each other, some of them are not shown in FIG. 6 and FIG. 7 to avoid complicating the representation.

FIG. 8 illustrates a cross-sectional perspective view of an artificial climbing structure made in the form of the parent outer climbing hold 13 and its individual elements-the bottom fixation element 34 in the form of a bolt and the fixation element 38 in the form of a screw. The hold 13 has the body 2, the outer surface 3, the base 4 and two non-intersecting daughter recesses 16a with inset lateral walls 17a, 27a and a bottom 18a and 16b with inset lateral walls 17b, 27b and a bottom 18b. Recesses 16a and 16b are formed by daughter receiving holes 24a and 24b on the surface 3 of the hold 13, walls 17a, 27a and 17b, 27b of receiving elements 26a and 26b and outer surfaces 36a and 36b of removable bottom parts 28a and 28b, respectively. The receiving elements 26a and 26b are made in the form of inner protrusions of the hold 13. The parts 28a and 28b are fixed to directed from the outer surface 3 and spaced from the inset surface 31 end portions 32a and 32b of the walls 17a, 27a and 17b, 27b of the receiving elements 26a and 26b with screw fixation elements 55a and 55b, respectively. For mounting screw fixation elements 55a of the removable bottom part 28a, through holes with conical recesses in the form of heads of screw fixation elements are made on the outer surface of the hold 13. The screw fixation elements 55b of the removable bottom part 28b are mounted in additional through fixation holes in the surface 3 of the hole 13 with conical recesses in the shape of the heads of the screw fixation elements 55b. Alternatively, the removable parts 28a and 28b of the bottom can be made in any other form, which is configured for their demountable mounting to the end surfaces 32a and 32b of the daughter receiving elements 26a and 26 and spaced at a given distance from the surface 3 of the body 13 from its inset side. In the outer surface 36a of the bottom 18a of the receiving recess 16a there is a through bottom fixation hole 33 of cylindrical shape with an extension 35 of the bottom fixation hole for mounting a bottom fixation element 34 therein with the lowering of the head of the bottom fixation element 34 into the extension 35. The shape of the bottom fixation hole 33 may differ from the cylindrical one. In the lateral wall 17b, 27b of the receiving recess 16b, there is a cylindrically shaped through lateral fixation hole 37 with an extension 39 for mounting the lateral fixation element 38 therein with the lowering the head of the lateral fixation element 38 into the extension 39. The shape of the lateral fixation hole 37 may differ from the cylindrical one.

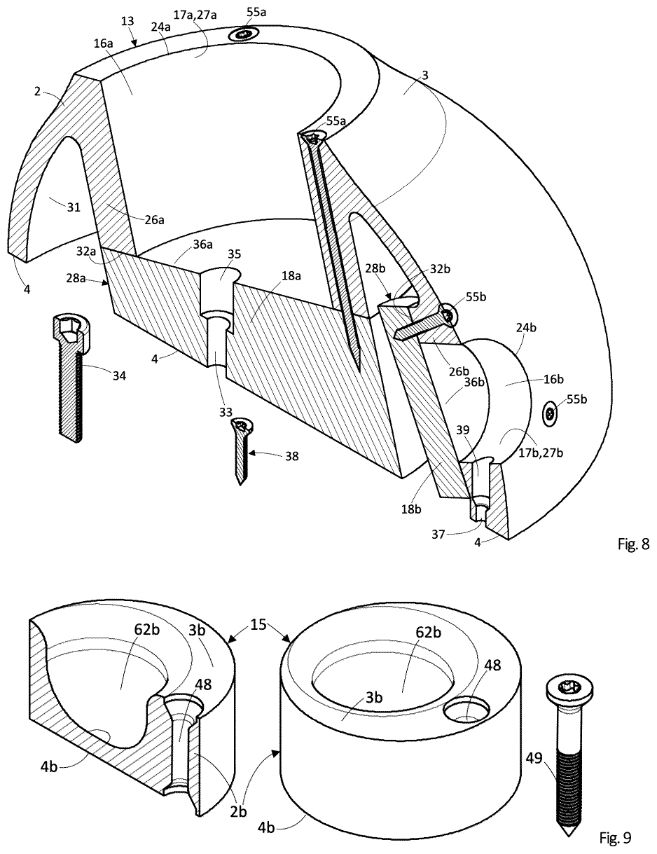

The left side of FIG. 9 illustrates a cross-sectional perspective view of the artificial climbing structure made as a double-sided reversible inset climbing hold 15, and the right side of FIG. 9 illustrates a cross-sectional perspective view of the same hold in perspective view without a cross-sectional view. The hold 15 has the cylindrical body 2b, the outer surface 3b, and the base 4b. In the central portion of the surface 3b, a recess 62b is made for the use of the hold 15 by the user during climbing. At the edge portion of the body from the surface 3b to the base 4b is a single through hole 48 of cylindrical shape. The shape of the hole 48 may differ from the cylindrical one. The hold 15 is provided for fixation to the bottom of the receiving recess 16, 16b (see FIGS. 8-10) by means of a fixation element 49 which, due to the fact that the axis of the hole 48 does not coincide with the axis of rotation of the body cylinder 2b, prevents rotation of the hold 15 in the receiving recess 16b under load. The advantage of using a single individual fixation element 49 is that a larger portion of the surface 3b of the hold 15 can be used for the recess 62b than when in case of the through fixation hole of conventional design arranged on the rotation axis of the cylindrical body 2b, or two or more through fixation holes arranged on the edge of the surface 3b of the body 2b. The base 4b is made smooth without recesses. The hold 15, mounted with the flat base 4b outside of the receiving recess 16, performs the function of a plug of the receiving recess 16. Alternatively, recesses 62b for use of the hold 15 by the user during climbing may be arranged simultaneously on the surface 3b and the base 4b, and may be of various shapes (not shown).

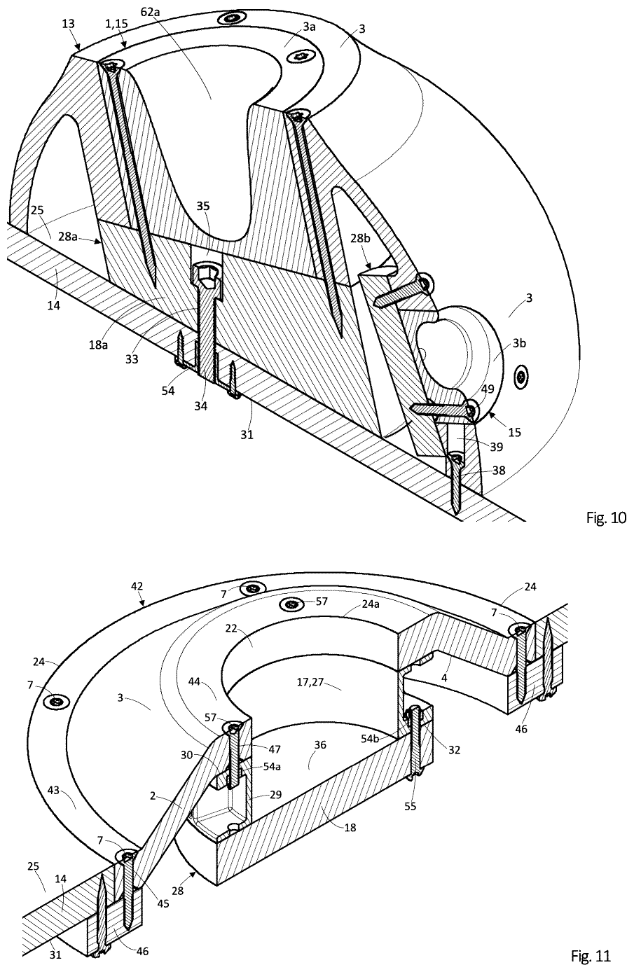

FIG. 10 shows a cross-sectional perspective view of the hold 13 according to FIG. 8 in the position fixed to the outer surface 25 of the structure 14 with its two daughter receiver recesses 16a and 16b fixed in the two daughter inset holds 1, 15 made in the form of the double-sided reversible inset climbing hold 15 according to FIG. 9 with surfaces 3a and 3b flush to the surface 3 of the hold 13, respectively. In the process of fixing the hold 13 to the structure 14, tight threaded connections are achieved between:
the bottom fixation element 34, pre-inserted from the side of the outer surface 36 of the bottom 18a of the recess 16a through the extension 35 into the through bottom fixation hole 33, and the t-nut 54, mounted from the side of the inset surface 31 of the structure 14,
the fixation element 38 pre-inserted from the side of the lateral wall 17b, 27b of the recess 16b (see FIG. 8) through the extension 39 into the through fixation hole 37 and the structure 14. In the position of fixation of the climbing hold 13 to the structure 14, the bottom and lateral fixation elements 34 and 38 tightly adjoint to the lower surfaces of the extensions 35 and 39, thereby retaining the hold 13 on the outer surface 25 of the structure 14. Therefore, the holds 1, 15 and 15, mounted into the recesses 16a and 16b, hide the bottom and lateral fixation elements 34 and 38 of the hold 13. All of the reference numbers in FIG. 8-FIG. 10 correspond to each other, some of which are not shown in FIG. 10 to avoid complicating the representation.

FIG. 11 illustrates a cross-sectional perspective view of an inset reversible climbing hold with a washer-shaped edge 42 in the position fixed in the parent receiving hole 24 on the outer surface 25 of the structure 14. The hold 42 is made as a three-dimensional part and has the body 2, the outer surface 3, the base 4, the daughter receiving recess 22, an outer washer edge 43 with six through outer edge mounting holes 45 (FIG. 11 shows only four of them) and an inset washer-shaped edge 44 framing the recess 22 with three through inset edge mounting holes 47 (FIG. 11 shows only two of them). An edge section of the receiving hole 24 in the structure 14 has a support portion 46 fixed on the inset surface 31 of the structure 14 and protruding inside the receiving hole 24 to the width of the outer washer-shaped edge 43. The hold 42 is supported by its outer washer-shaped edge 43 in the plane of the base 4 on the support portion 46 and is fixed thereon with the fixation elements 7 through the outer edge holes 45. The daughter receiving recess 22 is formed by:
Daughter receiving hole 24a extending from surface 3 to the base 4 of the hold 42,
Removable mounting sleeve 29 (shown in FIG. 5) fixed with the upper end portion 30 to the inset washer-shaped edge 44 of the hold 42 with screw fixation elements 57 and t-nuts 54a through the inset edge fixation holes 47 in the same manner as shown in FIG. 7,
The removable part 28 of the bottom fixed to the directed from the outer surface 3 lower end portion 32 of the removable mounting sleeve 29 with screw fixation elements 55 and t-nuts 54b in the same manner as shown in FIG. 7.

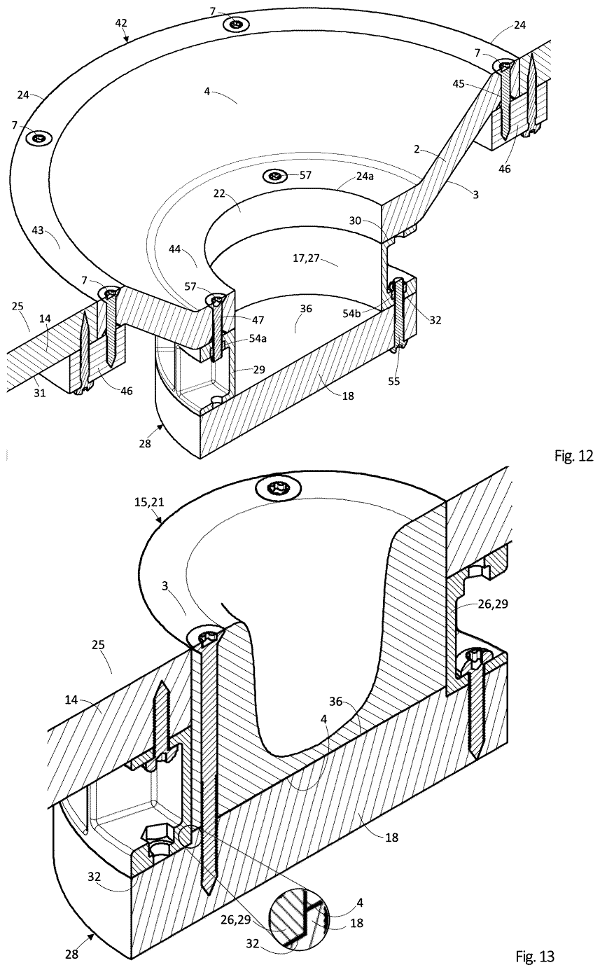

FIG. 12 illustrates a cross-sectional perspective view of the hold 42 according to the FIG. 11 fixed in the receiving hole 24 on the surface 25 of the structure 14 in the upside-down position. The removable mounting sleeve 29 (shown in FIG. 5) with the removable bottom part 28 of the bottom fixed with screw fixation elements 55 and t-nuts 54b on the lower end portion 32 of the removable mounting sleeve 29 is fixed with its upper end portion 30 on the inset washer-shaped edge 44 of the hold 42 from the side of the outer surface 3 of the hold 42 with the fixation elements 57 and t-nuts 54a through the inset edge fixation holes 47 in the same manner as illustrated in FIG. 11. The hold 42 supports by its outer washer-shaped edge 43 from the side of the outer surface 3 on the support portion 46 and is fixed on it with fixation elements 7 through the outer edge fixation holes 45. Thereby the outer surface 3 and the base 4 of the hold 42 are interchanged. All reference numbers in FIG. 11 and FIG. 12 coincide with each other.

FIG. 13 illustrates a cross-sectional perspective view of the daughter inset climbing hold 15, 21, mounted with its outer surface 3 flush to the outer surface 25 of the artificial climbing structure 14 in the receiving recess 16 in the structure 14 according to FIG. 6.

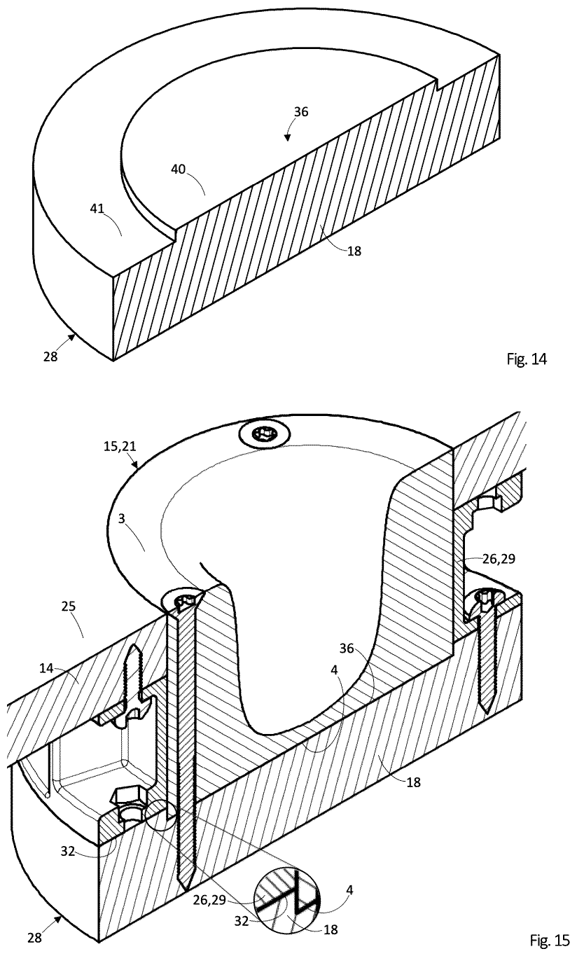

FIG. 14 illustrates a separate cross-sectional perspective view of the removable part 28 of the bottom of the receiving recess shown in FIG. 13. In this case, the thickness of the artificial climbing structure 14 with the receiving recess 16 exceeding the standard thickness for which the removable mounting sleeve 29 is designed, so that a depth of the receiving recess 16 (see FIG. 6) does not exceed a height of the recess 15, 21, the central portion 40 of the removable part 28 of the bottom of the receiving recess is arranged above the edge portion 41 of the removable part 28 so that a depth of the receiving recess 16 is equal to the height of the recess 15,21.

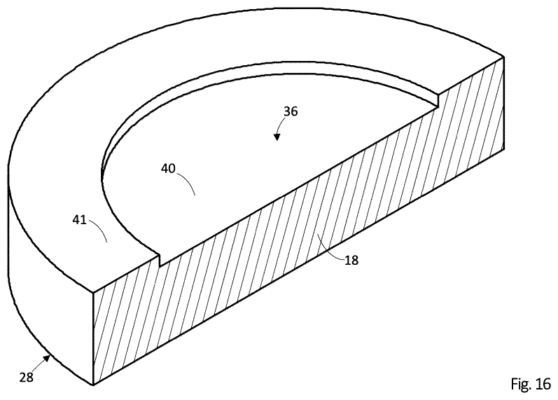

FIG. 15 illustrates, similarly to FIG. 13, a cross-sectional perspective view of the daughter inset climbing hold 15, 21 according to FIG. 4 and FIG. 5, mounted by surface 3 flush to the outer surface 25 of the artificial climbing structure 14 in the receiving recess 16 in the structure 14. FIG. 16 illustrates a separate cross-sectional perspective view of the removable part 28 of the bottom of the receiving recess. In this case, a thickness of the artificial climbing structure 14 with the receiving recess 16 is smaller than the standard thickness for which the removable mounting sleeve 29 is designed, so that a depth of the recess 16 is equal to a depth of the receiving recess 15,21 (see FIG. 6), the central portion 40 of the removable part 28 of the bottom of the receiving recess is arranged below the edge portion 41 of the part 28 so that the depth of the recess 16 is equal to that of the height of the hold 15. The reference numbers in FIG. 6, FIG. 13, FIG. 14, FIG. 15 and FIG. 16 correspond to each other.

What is claimed is:

1. An artificial climbing structure (14) having an outer (25) and an inset (31) surface, as well as at least one receiving recess (16) to fix an inset climbing hold (15) therein, wherein the receiving recess (16) is formed by:
a receiving hole (24) on the outer surface (25) of the artificial climbing structure (14),
a receiving element (2) with inset lateral walls (27) having an end surface (32), directed away from the outer surface (25) of the artificial climbing structure (14) and spaced at a set distance from the inset surface (31) of the artificial climbing structure (14), wherein the inset lateral walls (27) are made to cover a lateral surface (19) of a body (2) provided for mounting the inset climbing hold (15) into the receiving recess (16),
a bottom (18) of the receiving element (26) being arranged on an end portion (32) of inset lateral walls (27) faced from the outer surface (25) of the artificial climbing structure (14), and being designed for adjoining to a base (4) provided for mounting into the receiving recess (16) of the inset climbing hold (15), and also being designed for fixation of the inset climbing hold (15) with its base (4) to said bottom (18) by means of at least one fixation element (7),
characterized in that the bottom (18) of the receiving element (26) is made as a separate removable part (28) being designed for removable fixation to an end surface (32) of inset lateral walls (27) of the receiving element (26).

2. The artificial climbing structure (14) according to the claim 1, wherein the artificial climbing structure (14) is an external climbing hold (13).

3. The artificial climbing structure (14) according to the claim 1, wherein the artificial climbing structure (14) is an inset climbing hold (15).

4. The artificial climbing structure (14) according to the claim 1, characterized in that at least portion of inset lateral walls (27) of a receiving element (26) is made as a separate removable mounting sleeve (29) being adapted for fixation with its upper end surface (30) to an inset surface (31) of the artificial climbing structure (14) opposite to a receiving hole (24) of a receiving recess (16), and also being configured for fixation to its lower end surface (32) of a removable part (28) of a bottom (18) of the receiving element (26).

5. The artificial climbing structure (14) according to the claim 2, characterized in that at least portion of inset lateral walls (27) of a receiving element (26) is made as a separate removable mounting sleeve (29) being adapted for fixation with its upper end surface (30) to an inset surface (31) of the artificial climbing structure (14) opposite to a receiving hole (24) of a receiving recess (16), and also being configured for fixation to its lower end surface (32) of a removable part (28) of a bottom (18) of the receiving element (26).

6. The artificial climbing structure (14) according to the claim 3, characterized in that at least portion of inset lateral walls (27) of a receiving element (26) is made as a separate removable mounting sleeve (29) being adapted for fixation with its upper end surface (30) to an inset surface (31) of the artificial climbing structure (14) opposite to a receiving hole (24) of a receiving recess (16), and also being configured for fixation to its lower end surface (32) of a removable part (28) of a bottom (18) of the receiving element (26).

7. The artificial climbing structure (14) according to the claim 2 representing the removable outer climbing hold (13) with a base (4), characterized in that it is equipped with at least one bottom fixation hole (33), arranged in a bottom (18) of a receiving element (26), being adapted for inserting through said bottom fixation hole (33) of a bottom fixation element (34) of said outer climbing hold (13) with its fixation portion (9) toward to the base (4) of said outer climbing hold (13) with the protruding of a fixation portion (9) beyond the surface of said base (4).

8. The artificial climbing structure (14) according to the claim 5 representing the removable outer climbing hold (13) with a base (4), characterized in that it is equipped with at least one bottom fixation hole (33), arranged in a bottom (18) of a receiving element (26), being adapted for inserting through said bottom fixation hole (33) of a bottom fixation element (34) of said outer climbing hold (13) with its fixation portion (9) toward to the base (4) of said outer climbing hold (13) with the protruding of a fixation portion (9) beyond the surface of said base (4).

9. The artificial climbing structure (14) according to the claim 2 representing a removable outer climbing hold (13) with a base (4), characterized in that through a surface of an inset lateral wall (27b) and the base (4) of a receiving element (26) passes at least one lateral fixation hole (37) being designed for inserting a lateral fixation element (38) through it, with protruding of its fixation portion (9b) toward to the base (4) of said outer climbing hold (13) with the protrusion of a fixation portion (9b) beyond a surface of said base (4).

10. The artificial climbing structure (14) according to the claim 5 representing a removable outer climbing hold (13) with a base (4), characterized in that through a surface of an inset lateral wall (27b) and the base (4) of a receiving element (26) passes at least one lateral fixation hole (37) being designed for inserting a lateral fixation element (38) through it, with protruding of its fixation portion (9b) toward to the base (4) of said outer climbing hold (13) with the protrusion of a fixation portion (9b) beyond a surface of said base (4).

11. The artificial climbing structure (14) according to the claim 6 wherein the artificial climbing structure (14) is an inset climbing hold (15) representing a reversible double-sided parent inset climbing hold to mount it into a receiving hole (24) on an outer surface (25) of the artificial climbing structure made as a three-dimensional part with at least one daughter receiving hole (22), wherein an outer edge (43) and an insert edge (44) of the daughter receiving hole (22) made washer-shaped, wherein on an outer washer-shaped edge (43) of the reversible double-sided parent inset climbing hold (42) at least two through outer edge fixation holes (45) are arranged, or notches for its fixation to at least one supporting portion (46) protruding inside the receiving hole (24) and mounted on an inset surface (31) of the artificial climbing structure (14), wherein on the inset washer-shaped edge (44) of the daughter receiving hole (22) at least two through inset edge fixation holes (47) are arranged for fixation to the inset washer-shaped edge (44) of the daughter receiving hole (22) of a removable mounting sleeve (29) opposite to the daughter receiving hole (22) on either side of it.

12. The artificial climbing structure (14) according to the claim 1, wherein a height of an inset daughter climbing hold (15), defined by a distance from an outer edge of its outer surface (3) to its base (4) does not match a depth of the receiving recess (16), defined by a distance from the outer surface (25) of the artificial climbing structure (14) of the inset lateral walls (27) of the receiving element (26) to an end portion (32), reversed from it, wherein a bottom (18) of the receiving element (26) has:
a central portion (40), to which the base (4) of a body (2) of the inset daughter climbing hold (15) at least partially adjoins in the position mounted in the receiving recess (16), and
an edge portion (41) which is at least partially adjoins the edge portion (32) of the inset lateral walls (27) of the receiving element (26),
wherein in the case when a depth of the receiving recess (16) exceeds a height of the inset daughter climbing hold (15), the central portion (40) of the bottom (18) of the receiving element (26) is arranged above the edge portion (41) of the bottom (18) of the receiving element (26) to a difference of these distances,
and in the case when a height of the inset daughter climbing hold (15) exceeds a depth of the receiving recess (16), then the central portion (40) of the bottom (18) of the receiving element (26) is arranged below the edge portion (41) of the bottom (18) of the receiving element (26) to a difference of these distances.

13. The artificial climbing structure (14) according to the claim 2, wherein a height of an inset daughter climbing hold (15), defined by a distance from an outer edge of its outer surface (3) to its base (4) does not match a depth of the receiving recess (16), defined by a distance from the outer surface (25) of the artificial climbing structure (14) of the inset lateral walls (27) of the receiving element (26) to an end portion (32), reversed from it,
wherein a bottom (18) of the receiving element (26) has:
a central portion (40), to which the base (4) of a body (2) of the inset daughter climbing hold (15) at least partially adjoins in the position mounted in the receiving recess (16), and
an edge portion (41) which is at least partially adjoins the edge portion (32) of the inset lateral walls (27) of the receiving element (26),
wherein in the case when a depth of the receiving recess (16) exceeds a height of the inset daughter climbing hold (15), the central portion (40) of the bottom (18) of the receiving element (26) is arranged above the edge portion (41) of the bottom (18) of the receiving element (26) to a difference of these distances,
and in the case when a height of the inset daughter climbing hold (15) exceeds a depth of the receiving recess (16), then the central portion (40) of the bottom (18) of the receiving element (26) is arranged below the edge portion (41) of the bottom (18) of the receiving element (26) to a difference of these distances.

14. The artificial climbing structure (14) according to the claim 3, wherein a height of an inset daughter climbing hold (15), defined by a distance from an outer edge of its outer surface (3) to its base (4) does not match a depth of the receiving recess (16), defined by a distance from the outer surface (25) of the artificial climbing structure (14) of the inset lateral walls (27) of the receiving element (26) to an end portion (32), reversed from it,
wherein a bottom (18) of the receiving element (26) has:
a central portion (40), to which the base (4) of a body (2) of the inset daughter climbing hold (15) at least partially adjoins in the position mounted in the receiving recess (16), and
an edge portion (41) which is at least partially adjoins the edge portion (32) of the inset lateral walls (27) of the receiving element (26),
wherein in the case when a depth of the receiving recess (16) exceeds a height of the inset daughter climbing hold (15), the central portion (40) of the bottom (18) of the receiving element (26) is arranged above the edge portion (41) of the bottom (18) of the receiving element (26) to a difference of these distances,
and in the case when a height of the inset daughter climbing hold (15) exceeds a depth of the receiving recess (16), then the central portion (40) of the bottom (18) of the receiving element (26) is arranged below the edge portion (41) of the bottom (18) of the receiving element (26) to a difference of these distances.

15. The artificial climbing structure (14) according to the claim 4, wherein a height of an inset daughter climbing hold (15), defined by a distance from an outer edge of its outer surface (3) to its base (4) does not match a depth of the receiving recess (16), defined by a distance from the outer surface (25) of the artificial climbing structure (14) of the inset lateral walls (27) of the receiving element (26) to an end portion (32), reversed from it,
wherein a bottom (18) of the receiving element (26) has:
a central portion (40), to which the base (4) of a body (2) of the inset daughter climbing hold (15) at least partially adjoins in the position mounted in the receiving recess (16), and
an edge portion (41) which is at least partially adjoins the edge portion (32) of the inset lateral walls (27) of the receiving element (26),
wherein in the case when a depth of the receiving recess (16) exceeds a height of the inset daughter climbing hold (15), the central portion (40) of the bottom (18) of the receiving element (26) is arranged above the edge portion (41) of the bottom (18) of the receiving element (26) to a difference of these distances,
and in the case when a height of the inset daughter climbing hold (15) exceeds a depth of the receiving recess (16), then the central portion (40) of the bottom (18) of the receiving element (26) is arranged below the edge portion (41) of the bottom (18) of the receiving element (26) to a difference of these distances.

16. The artificial climbing structure (14) according to the claim 7, wherein a height of an inset daughter climbing hold (15), defined by a distance from an outer edge of its outer surface (3) to its base (4) does not match a depth of the receiving recess (16), defined by a distance from the outer surface (25) of the artificial climbing structure (14) of the inset lateral walls (27) of the receiving element (26) to an end portion (32), reversed from it,
wherein a bottom (18) of the receiving element (26) has:
a central portion (40), to which the base (4) of a body (2) of the inset daughter climbing hold (15) at least partially adjoins in the position mounted in the receiving recess (16), and
an edge portion (41) which is at least partially adjoins the edge portion (32) of the inset lateral walls (27) of the receiving element (26),
wherein in the case when a depth of the receiving recess (16) exceeds a height of the inset daughter climbing hold (15), the central portion (40) of the bottom (18) of the receiving element (26) is arranged above the edge portion (41) of the bottom (18) of the receiving element (26) to a difference of these distances,
and in the case when a height of the inset daughter climbing hold (15) exceeds a depth of the receiving recess (16), then the central portion (40) of the bottom (18) of the receiving element (26) is arranged below the edge portion (41) of the bottom (18) of the receiving element (26) to a difference of these distances.

17. The artificial climbing structure (14) according to the claim 8, wherein a height of an inset daughter climbing hold (15), defined by a distance from an outer edge of its outer surface (3) to its base (4) does not match a depth of the receiving recess (16), defined by a distance from the outer surface (25) of the artificial climbing structure (14) of the inset lateral walls (27) of the receiving element (26) to an end portion (32), reversed from it,
wherein a bottom (18) of the receiving element (26) has:
a central portion (40), to which the base (4) of a body (2) of the inset daughter climbing hold (15) at least partially adjoins in the position mounted in the receiving recess (16), and
an edge portion (41) which is at least partially adjoins the edge portion (32) of the inset lateral walls (27) of the receiving element (26),
wherein in the case when a depth of the receiving recess (16) exceeds a height of the inset daughter climbing hold (15), the central portion (40) of the bottom (18) of the receiving element (26) is arranged above the edge portion (41) of the bottom (18) of the receiving element (26) to a difference of these distances,
and in the case when a height of the inset daughter climbing hold (15) exceeds a depth of the receiving recess (16), then the central portion (40) of the bottom (18) of the receiving element (26) is arranged below the edge portion (41) of the bottom (18) of the receiving element (26) to a difference of these distances.

18. The artificial climbing structure (14), which is a one-sided or double-sided reversible inset climbing hold (15) having a cylindrical body (2b) with the an outer surface (3b) and a base (4b), mountable into the receiving recess (16) of the artificial climbing structure (14) according to the claim 1, characterized in that it has one through fixation and mounting hole (48) arranged in a body (2) from an outer working surface (3) towards to a base (4) an axis of which is arranged in parallel and not matching with the axis of symmetry of the cylinder of a body (2) of the hold (15).

19. The artificial climbing structure (14), which is a one-sided or double-sided reversible inset climbing hold (15) having a cylindrical body (2b) with the an outer surface (3b) and a base (4b), mountable into the receiving recess (16) of the artificial climbing structure (14) according to the claim 4, characterized in that it has one through fixation and mounting hole (48) arranged in a body (2) from an outer working surface (3) towards to a base (4), an axis of which is arranged in parallel and not matching with the axis of symmetry of the cylinder of a body (2) of the hold (15).

20. The artificial climbing structure (14), which is a one-sided or double-sided reversible inset climbing hold (15) having a cylindrical body (2b) with the an outer surface (3b) and a base (4b), mountable into the receiving recess (16) of the artificial climbing structure (14) according to the claim 7, characterized in that it has one through fixation and mounting hole (48) arranged in a body (2) from an outer working surface (3) towards to a base (4), an axis of which is arranged in parallel and not matching with the axis of symmetry of the cylinder of a body (2) of the hold (15).
